(19) United States
(12) Patent Application Publication
(10) Pub. No.: US 2011/0208586 A1
(43) Pub. Date: Aug. 25, 2011

(54) Leveraging Demographic Data for Advertising Purposes

(75) Inventors: David JOA, Irvine, CA (US); Debashis GHOSH, Charlotte, NC (US); Kurt NEWMAN, Matthews, NC (US); Timothy BENDEL, Charlotte, NC (US); Steve HILL, Ponte Vedra Beach, FL (US)

(73) Assignee: BANK OF AMERICA CORPORATION, Charlotte, NC (US)

(21) Appl. No.: 12/712,341

(22) Filed: Feb. 25, 2010

(51) Int. Cl. G06Q 30/00; G06K 7/10

(52) U.S. Cl. 705/14.53; 235/375

(57) ABSTRACT

A computer assisted method selecting a potential audience for an advertisement wherein the method may include electronically receiving data relating to at least one financial transaction between a customer of an organization and a third party, electronically receiving data relating to at least one demographic of the customer, and using a demographic evaluation computer to determine a potential audience for an advertisement based on the financial transaction data and the demographic data. The method for determining a potential audience for an advertisement may include searching the electronically received demographic data for data that matches a first criterion which is related to the demographic data, searching the electronically received financial transaction data for data that matches a second criterion which is related to the financial transaction data, comparing the data that matches a first criterion with the data that matches the second criterion to determine which of the data matching the first criterion and the data matching the second criterion matches both the first and the second criterion, and compiling the data which matches both the first and the second criterion.

### FIELD OF DISCLOSURE

Aspects of the present disclosure relate generally to advertising. Particular aspects of the present disclosure relate to leveraging demographic data (including financial transaction data) in order to target advertising.

### BACKGROUND

Generally, an advertiser who is advertising a product or service attempts to make an advertisement as effective as possible by presenting the advertisement to an audience that is likely to be interested in the product or service (e.g., potential customers). If advertisement is presented to an audience that is unlikely to be interested in the advertisement, then the advertisement may not be effective as it would have been if the audience was likely to be interested in the advertisement. Hence, such an advertisement may not result in increased sales of the good or service. Therefore, it would be advantageous to have a system and method which aids an advertiser in targeting their advertising to an intended audience that is likely to be interested in the product. Such targeted advertising increases the likelihood of the effectiveness of an advertisement by presenting the advertisement to an audience that is likely to be interested in that particular product or service associated with the advertisement. Further, it would be advantageous to have a system and method which provides accurate information about an intended audience so the advertiser may leverage such information to target their advertising.

### SUMMARY

In light of the above, aspects of this disclosure relate to a computer assisted method selecting a potential audience for an advertisement wherein the method may include electronically receiving data relating to at least one financial transaction between a customer of an organization and a third party, electronically receiving data relating to at least one demographic of the customer, and using a demographic evaluation computer to determine a potential audience for an advertisement based on the financial transaction data and the demographic data. The method for determining a potential audience for an advertisement may include searching the electronically received demographic data for data that matches a first criterion which is related to the demographic data, searching the electronically received financial transaction data for data that matches a second criterion which is related to the financial transaction data, comparing the data that matches a first criterion with the data that matches the second criterion to determine which of the data matching the first criterion and the data matching the second criterion matches both the first and the second criterion, and compiling the data which matches both the first and the second criterion. Further, the first criterion may include a first characteristic of an intended audience to which the advertisement is to be presented and the second criterion may include a second characteristic of an intended audience to which the advertisement is to be presented. Additionally, searching the electronically received financial transaction data may include searching a database storing financial transaction data including financial transaction history associated with an account held with a bank.

Additional aspects of the disclosure relate to a demographic evaluation computer which may include a processor and memory storing computer executable instructions that, when executed, cause the demographic evaluation computer to perform a method for selecting a potential audience for an advertisement by electronically receiving data relating to at least one financial transaction between a customer of an organization and a third party, electronically receiving data relating to at least one demographic of the customer and determining a potential audience for an advertisement based on the financial transaction data and the demographic data. The method for selecting a potential audience for an advertisement may include searching the electronically received demographic data for data that matches a first criterion which is related to the demographic data, searching the electronically received financial transaction data for data that matches a second criterion which is related to the financial transaction data, comparing the data that matches a first criterion with the data that matches the second criterion to determine which of the data matching the first criterion and the data matching the second criterion matches both the first and the second criterion and compiling the data which matches both the first and the second criterion. The first criterion may include a first characteristic of an intended audience to which the advertisement is to be presented. The second criterion may include a second characteristic of an intended audience to which the advertisement is to be presented. Further, searching the electronically received financial transaction data may include searching a database storing financial transaction data including financial transaction history associated with an account held with a bank.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a diagram of a general-purpose digital computing environment in which certain aspects of the present disclosure may be implemented;

FIG. 2 is a diagram of an illustrative example of an system for leveraging demographic data according to at least one aspect of the present disclosure;

FIG. 3 is a screen shot of one feature of a system for leveraging demographic data according to at least one aspect of the present disclosure;

FIG. 4 is a screen shot of one feature of a system for leveraging demographic data according to at least one aspect of the present disclosure; and

FIGS. 5A and 5B are a flowchart of an illustrative method for leveraging demographic information according to at least one aspect of the present disclosure.

### DETAILED DESCRIPTION

In the following description of the various embodiments, reference is made to the accompanying drawings, which form a part hereof, and in which is shown by way of illustration various embodiments in which the disclosure may be practiced. It is to be understood that other embodiments may be utilized and structural and functional modifications may be made.

It is noted that throughout the disclosure, the term bank may be used interchangeably with organization, financial institution, business, etc. The term bank is not intended to be limiting, but rather merely describes a potential embodiment of the disclosure. Also, the term demographic data may be used throughout the disclosure. According to aspects of this disclosure, the term demographic data may include financial transaction data and other data.

Advertising via mass media, such as television, radio, the internet, print media (e.g., newspapers and magazines), etc. is a valuable method of presenting information about a product or service to a large audience. However, advertising in mass media may be expensive. For example, recently the cost of a thirty second media spot buy during the Super Bowl has been estimated to be three million dollars. Therefore, it is understood that when an entity (e.g., a company that manufactures a product or offers a service) expends the large amount of finances that may be required for such mass media advertising, it would be desirable for the advertisement to be effective and, thereby, increase the sales of the product or service.

As described above, advertising is more effective when it is presented to an audience that is likely to be interested in purchasing the product or service being advertised. Therefore, an entire industry has been created which is devoted to providing companies (e.g., companies selling the products or services being advertised) with data regarding potential target audiences (e.g., demographic information of potential target audiences) that may be reached through such advertising. For example, televisions ratings are based on a system that provides information about how many viewers are watching a particular program. Further, such television ratings services may be used to indicate demographic information about which viewers are watching particular television programs at particular times. Based on such demographic information, a company may tailor its advertising to particular time slots, channels, programs, etc.

However, such systems have drawbacks including the fact that the systems may be relatively inaccurate. For example, such television rating services are based solely on a limited number of households. For example, only a limited number of households have been selected by the television rating services to use the television rating services' equipment which provides information on the programs that the particular household is viewing. Hence, the ratings are actually extrapolated from the limited number households that have the equipment. Therefore, such a system may be relatively unreliable for providing accurate demographic information that can be used for advertising purposes. Additionally, such television services may have only a limited amount of demographic information for each household and, therefore, may not be able to provide an accurate picture of even the households in which they do have equipment. Hence, it would be beneficial to have a system that would provide more accurate demographic information about a potential audience that may be leveraged for advertising purposes.

According to aspects of the disclosure, financial transaction and other demographic data may used to provide more accurate information on the potential audience that an advertiser is attempting to reach. Therefore, banks may be in a unique position to determine and provide the accurate demographic information of a potential audience that an advertiser is attempting to reach. For example, using financial transaction data of a customer, a bank may determine the spending habits of that customer. Further, the bank would already have a multitude of other demographic information for the customer (e.g., the customers: age, residence (e.g., city or zip code), income level, income received from payroll, income received from cash dividends, type of household in which they live (e.g., single, married with or without children, lives in a house, condo, high rise, etc.) etc.). The bank may combine the financial transaction data (e.g., spending habits) of its customers with additional customer demographic information in order to create a more accurate and clearer picture of the bank customer. Further, according to aspects of the disclosure, the more accurate financial and other demographic information on the bank customers can be organized on an aggregate level wherein different anonymous groups of bank customers are identified instead of individual bank customers). Hence, accurate demographic information about the bank's customers may be provided. The accurate demographic information may be leveraged to provide an advertiser with information that can assist them in targeting their advertising to a particular audience that is likely to see and/or hear the advertisement and, further, is likely to be interested in the particular product or service associated with the advertisement.

As discussed above, if the advertising can be targeted to an audience that is likely to buy the product or service, then it is likely that the advertising will be more effective. Therefore, it would be advantageous for an advertiser to use such financial transaction and other demographic data regarding a potential audience to determine how to tailor the advertising of a product or service to the customer. Hence, aspects of this disclosure relate to a system and method for leveraging financial transaction and other demographic data to assist an advertiser in targeting advertising for a particular product or service to a particular audience. Further, it is noted, that aspects of this disclosure, relate to a system and method for leveraging financial transaction and other demographic data that includes guidelines for respecting customer privacy rights and protecting personal information of the customer. It is noted that an organization using such a system and method for leveraging financial transaction and other demographic data may have privacy guidelines that describe the policies regarding the handling of any data related to a customer that may contain private information (e.g., personal identification information, bank card numbers, etc.). Financial transaction data, in some embodiments, may contain such private information. According to aspects of the disclosure, in some embodiments, the system may provide feedback that conforms to the policies set forth in the privacy guidelines. According to aspects of the disclosure, the system and method may provide information that does not include a customer's private information (e.g., name or other identifying information, etc.). In some embodiments, the system may provide information wherein a customer's private information has been removed. For example, a system may provide information at an aggregate level. As another example, system may provide information that does not identify any individual and/or include other identifying information such as a bank card number. A system and method for leveraging such financial transaction and other demographic data for advertising purposes will be described in detail below.

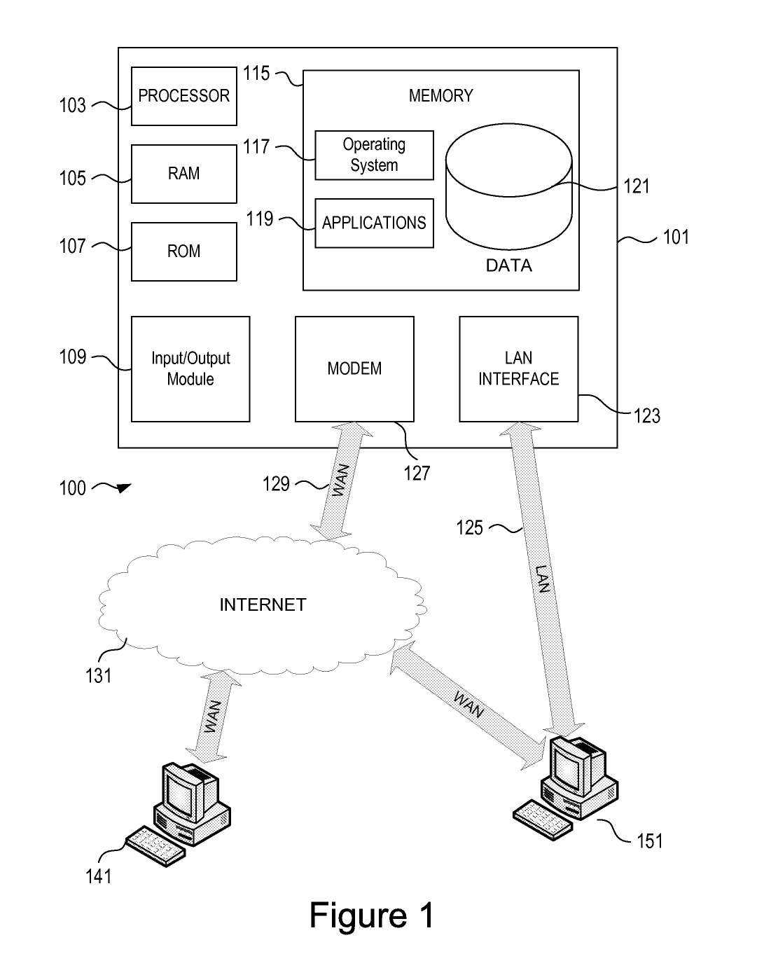

FIG. 1 illustrates an example of a suitable computing system environment 100 that may be used according to one or more illustrative embodiments of the disclosure. The computing system environment 100 is only one example of a suitable computing environment and is not intended to suggest any limitation as to the scope of use or functionality of the disclosure. Neither should the computing system environment 100 be interpreted as having any dependency nor requirement relating to any one or combination of components illustrated in the exemplary computing system environment 100.

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, etc. that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices.

With reference to FIG. 1, the computing system environment 100 may include a computer 101 having a processor 103 for controlling overall operation of the computer 101 and its associated components, including RAM 105, ROM 107, input/output module 109, and memory 115. Computer 101 typically includes a variety of computer readable media. Computer readable media may be any available media that may be accessed by computer 101 and include both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 101. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. Although not shown, RAM 105 may include one or more are applications representing the application data stored in RAM memory 105 while the computer is on and corresponding software applications (e.g., software tasks), are running on the computer 101.

Input/output module 109 may include a microphone, keypad, touch screen, scanner, optical scanner and/or stylus through which a user of computer 101 may provide input, and may also include one or more of a speaker for providing audio output and a video display device for providing textual, audiovisual and/or graphical output. Software may be stored within memory 115 and/or storage to provide instructions to processor 103 for enabling computer 101 to perform various functions. For example, memory 115 may store software used by the computer 101, such as an operating system 117, application programs 119, and an associated database 121. Alternatively, some or all of computer 101's computer executable instructions may be embodied in hardware or firmware (not shown). As described in detail below, the database 121 may provide centralized storage of account information and account holder information for the entire business, allowing interoperability between different elements of the business residing at different physical locations.

Computer 101 may operate in a networked environment supporting connections to one or more remote computers, such as branch terminals 141 and 151. The branch computers 141 and 151 may be personal computers or servers that include many or all of the elements described above relative to the computer 101. The network connections depicted in FIG. 1 include a local area network (LAN) 125 and a wide area network (WAN) 129, but may also include other networks. When used in a LAN networking environment, computer 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are exemplary and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, an application program 119 used by the computer 101 according to an illustrative embodiment of the disclosure may include computer executable instructions for invoking user functionality related to communication, such as email, short message service (SMS), and voice input and speech recognition applications.

Terminals 141 or 151 may also be mobile terminals including various other components, such as a battery, speaker, and antennas (not shown). Input/output module 109 may include a user interface including such physical components as a voice interface, one or more arrow keys, joystick, data glove, mouse, roller ball, touch screen, scanner, optical scanner, or the like. Further, it is noted that aspects of the disclosure may include a standard application programming interface (API).

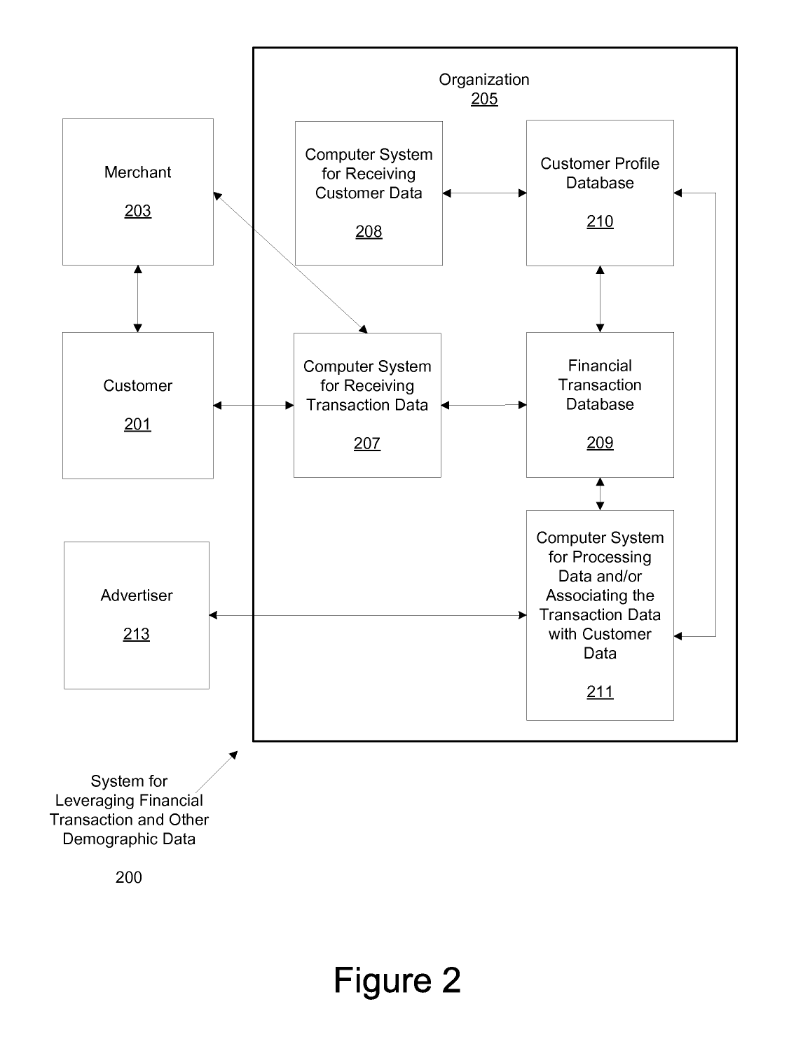

FIG. 2 is a diagram which shows a system for leveraging financial transaction and other demographic data 200 according to aspects of this disclosure. As seen in FIG. 2, a customer 201 conducts a financial transaction with a merchant 203. According to aspects of this disclosure, the customer 201 may upload information regarding the financial transaction to the organization 205 via a computer system for receiving transaction data 207. It is noted that according to some aspects of the disclosure, alternatively, or additionally, the merchant 203 may also transmit information regarding the financial transaction to the organization 205 via the computer system for receiving transaction data 207. According to aspects of the disclosure, the system for leveraging transaction and other demographic data 200 may also include one or more financial transaction databases 209 which store data related to financial transactions. The computer system for receiving transaction data 207 may transmit data to and receive data from one or more of the organization's financial transaction databases 209. According to aspects of the disclosure, the system for leveraging financial transaction and other demographic data 200 may also include a computer system for receiving customer data 208. Further, according to aspects of the disclosure, the system for leveraging financial transaction and other demographic data 200 may also include one or more customer profile databases 210 which stores data related to customers. The financial transaction database 209 may transmit data to and receive data from one or more of the organization's customer profile databases 210.

Further, according to aspects of the disclosure, the system for leveraging financial transaction and other demographic data 200 may includes a computer system for processing data and/or associating transaction data with customer data 211. As seen in FIG. 2, the computer system 211 may transmit data to and receive data from each of the transaction database 209 and the customer profile database 210. Further, as seen in FIG. 2, computer system 211 may transmit data to and receive data from an advertiser 213 or other third party (e.g., a media broker). The above described system for leveraging financial transaction and other demographic data 200 represented in FIG. 2 will be described in more detail below. However, it is noted here that one or more of the elements in the above described system 200 (e.g., the computer system for receiving transaction data 207, the computer system for receiving customer data 208, databases 209 and 210, computer system for processing data and/or associating the transaction data with customer data 211) may include a computer system with a processor, a memory or both.

As described above, according to aspects of this disclosure, a bank may have one or more computer systems 208 that are used for capturing and processing data related to customers' profiles. For example, a bank may have one or more computer systems 208 that are used for capturing and processing data about current customers and their financial relationships with the bank, such as: customer name, address, telephone number, email address, age, synthetic ratios, bank developed scores, income, income received from payroll, income received from cash dividends, debt, place of employment (and its contact information, such as address, telephone numbers, etc.), type of household (e.g., double income household, children, single adult), type of residence (home owner (e.g., condo, house), renter (e.g., apartment)), the type of financial relationship/account (e.g., a loan, insurance, deposit account, checking account, savings account, etc.), term of the relationship (e.g., term of a loan, the time current customer has been with the bank, etc.), particular relevant financial amounts in the relationship (e.g., monthly payments, total debt, interest rate, etc.), if one or more of the payments on the account have been made from a deposit account with a second bank, routing numbers and account numbers, whether automatic payments are set up to receive funds from a second bank, etc. The computer systems 208 used for capturing and processing customer profile data, may be configured to allow customers to input such customer profile data (e.g., via a web based system) or allow bank employees to enter such customer profile data. Further, the computer systems 208 may include one or more databases 210 for storing the customer profile data. For example, if the customer 201 or bank employee enters such customer profile data, then the customer profile data may be stored in a database 210 associated with the computer systems 208 used for capturing and processing customer profile data. Also, the computer systems 208 used for capturing and processing current customer profile may be configured to transmit the customer profile data (e.g., to other computer systems or databases within the organization 205).

As described above, according to aspects of this disclosure, a bank may have one or more computer systems 207 that are used for receiving and processing data related to a financial transaction between a bank customer and a merchant. Examples of data related to a financial transaction between a bank customer and a merchant, may include: the date of the financial transaction, the time of the financial transaction, the location of the financial transaction, the merchant 203 and customer 201 with whom the financial transaction was conducted, the items purchased by the customer during a financial transaction, etc.

The computer systems 207 used for receiving and processing transaction data, may be configured to allow customers to input such financial transaction data (e.g., via a web based system). For example, as will be described in detail below, the customer may upload a receipt of the financial transaction (e.g., an electronic scanned-in copy of the receipt of the financial transaction). According to aspects of the disclosure, the computer systems 207 for receiving and processing financial transaction data 207 may include one or more scanning devices which scan the receipts uploaded by the customer to the computer system 207 and, further, transmit the data for storage in one or more databases (e.g., financial transaction databases 209). Further, the computer systems 207 may be configured to extract and read the information from the electronic image of the receipt (e.g., via Optical Character Recognition (OCR) software or the like) and, also, be configured to transmit and receive such information obtained from the electronic image of the receipt. According to other aspects of the disclosure, a customer 201 may manually enter the financial transaction data (e.g., via a web-based system). It is noted that according to some aspects of the disclosure (and as described in detail below), the computer system for receiving and processing transaction data 207, may be configured to receive such transaction data directly from the merchants 203 with whom the financial transaction was conducted.

Further, the computer systems 207 may include one or more databases 209 for storing the financial transaction data. For example, if a customer 201 enters financial transaction data, then the financial transaction data may be stored in a financial transaction database 209 associated with the computer systems 207 used for receiving and processing transaction data. Also, the financial transaction database 209 used for receiving and processing transaction data may be configured to transmit the financial transaction data (e.g., to other computer systems or databases within the organization 205).

Further, as described above, according to one or more aspects of the disclosure, the organization 205 may have one or more computer systems 211 for processing data and/or associating the transaction data with customer data. For example, the computer system 211 may be configured to search for, indentify, extract and process data from the above described transaction database 209 and customer profile database 210. For example, according to one or more aspects of this disclosure, the computer systems 211 may be configured to search customer profiles for any relevant customer information that has been defined as search criteria by the organization 205 and extract such data. An example of search criteria may be male customers with an age between 20-34 years old. Further, once those accounts matching the search criteria are identified, the computer systems 211 may also search the financial transaction database 209 for financial transaction data that has defined as search criteria by the organization 205 and is further in financial transaction accounts related to the identified customers and extract such financial transaction data. Additionally, according to some aspects of the disclosure, and as will be described in detail below, the computer system 211 may process the customer data and the transaction data that has been extracted in order to provide accurate demographic information (e.g., an aggregate of demographic information of the bank's customers) that may be used for advertising purposes. Also, the computer system 211 may compile the data in a format specified by the user (e.g., a list or spreadsheet).

An illustrative system for leveraging financial transaction and other demographic data 200 will be described in detail below with reference to the FIG. 2. According to aspects of this disclosure, in order for a customer 201 to participate in the system 200, the customer 201 may be required to register with the organization 205. According to an embodiment of the disclosure, wherein the organization 205 is a bank, the customer 201 may have an account with the bank (e.g., a deposit account), have provided particular information to the bank, such as contact information, residence information, financial information (e.g., income level), or other demographic information such as described above.

According to aspects of this disclosure, if a customer 201 registers with the organization 205 and participates in the system 200, then the customer 201 may be assigned a personal account (associated with their other account(s) with the bank) through which the customer 201 may upload financial transaction information to the organization's computer system for receiving transaction data 207. According to aspects of the disclosure, the computer system for receiving financial transaction data 207 may be a web based system. Therefore, according to aspects of the disclosure, the customer 201 may access the computer system for receiving financial transaction data 207 via the internet from a personal computer, smart phone, etc. by, for example, providing an identification number (such as an account number) and password. Of course, other methods of authenticating the customer 201 may be used as well. Once the customer 201 has accessed the account, the customer 201 may upload financial transaction data to the computer system for receiving financial transaction data 207.

For example, as seen in FIG. 2, when the customer 201 conducts the financial transaction with a merchant 203, useful information regarding the financial transaction may be available. Therefore, according to aspects of this disclosure, the customer 201 may transmit data regarding the financial transaction to the computer system 207. For example, the customer 201 may obtain a receipt from the transaction with the merchant 203. Therefore, subsequent to the financial transaction, the customer 201 may create an electronic copy of the receipt and upload the receipt to the computer system 207 via a web based interface associated with the computer system 207. For example, according to aspects of this disclosure, the receipt may be in an electronic format such as, Protected Document Format (PDF).

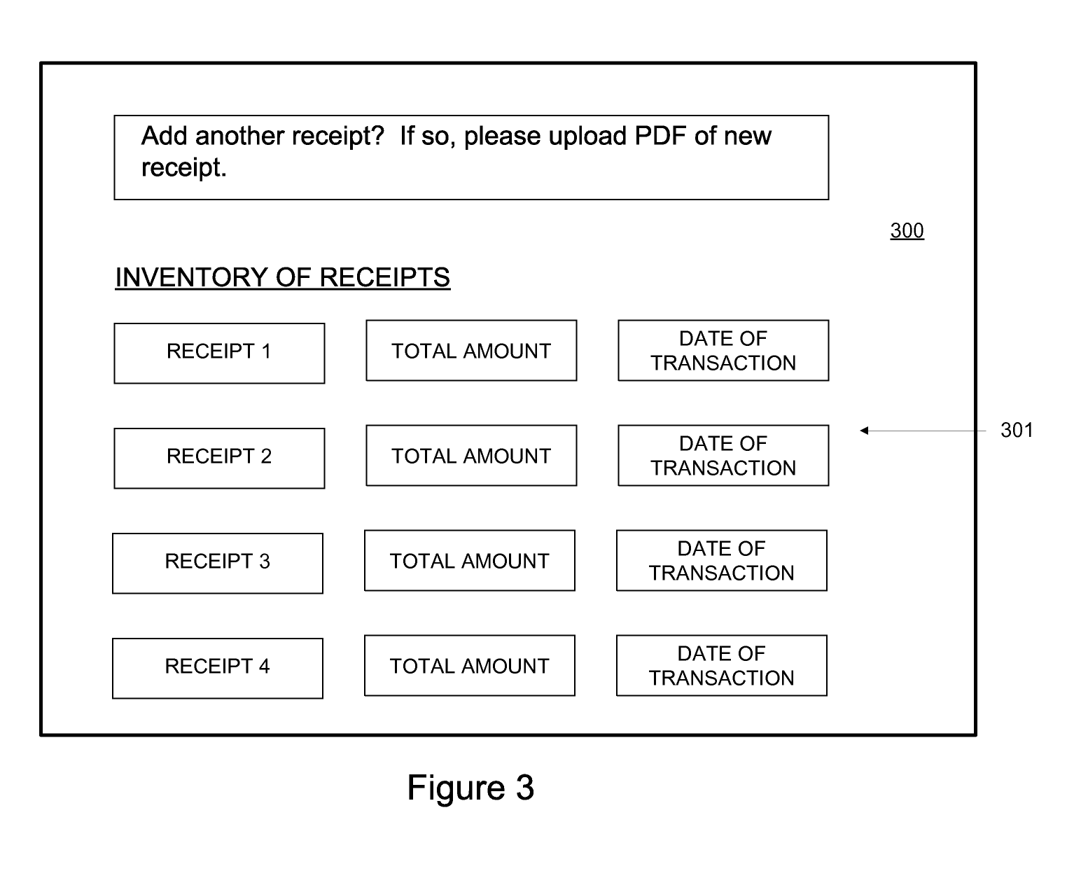

FIG. 3 is a screen shot of an illustrative embodiment of a web based interface 300 for uploading transaction data to the computer for receiving financial transaction data 207. It is noted that as seen in FIG. 3, web based interface 300 may store multiple PDFs 301. As seen in FIG. 3, the interface 300 may include fields 301 for other information regarding the financial transaction. According to aspects of the disclosure, such fields 301 may be populated manually by the computer or automatically by the computer system 207 via OCR or other software as will be described in detail below. Once the one or more receipts has been uploaded to the computer system 207 via the web based interface 300 associated with the computer system 207, the customer 203 may have an opportunity to review the receipt(s) prior to submitting the receipt(s) to the organization 205 via computer system 207.

As discussed above, the computer system for receiving transaction data 207 may include OCR software which may extract the information regarding the financial transaction from the scanned in copy of the receipt. For example, the OCR software may extract financial transaction data, such as: the date of the financial transaction, and time of the financial transaction, location of the financial transaction, the identity of the merchant 205 and/or customer 201involved with the financial transaction, the amount of funds involved in the financial transaction, the individual items purchased in the financial transaction, etc. Further, according to aspects of the disclosure, the computer system 207 may use software that recognizes the UPC codes contained in the receipt to extract identifying information on the individual items purchased or otherwise involved in the financial transaction.

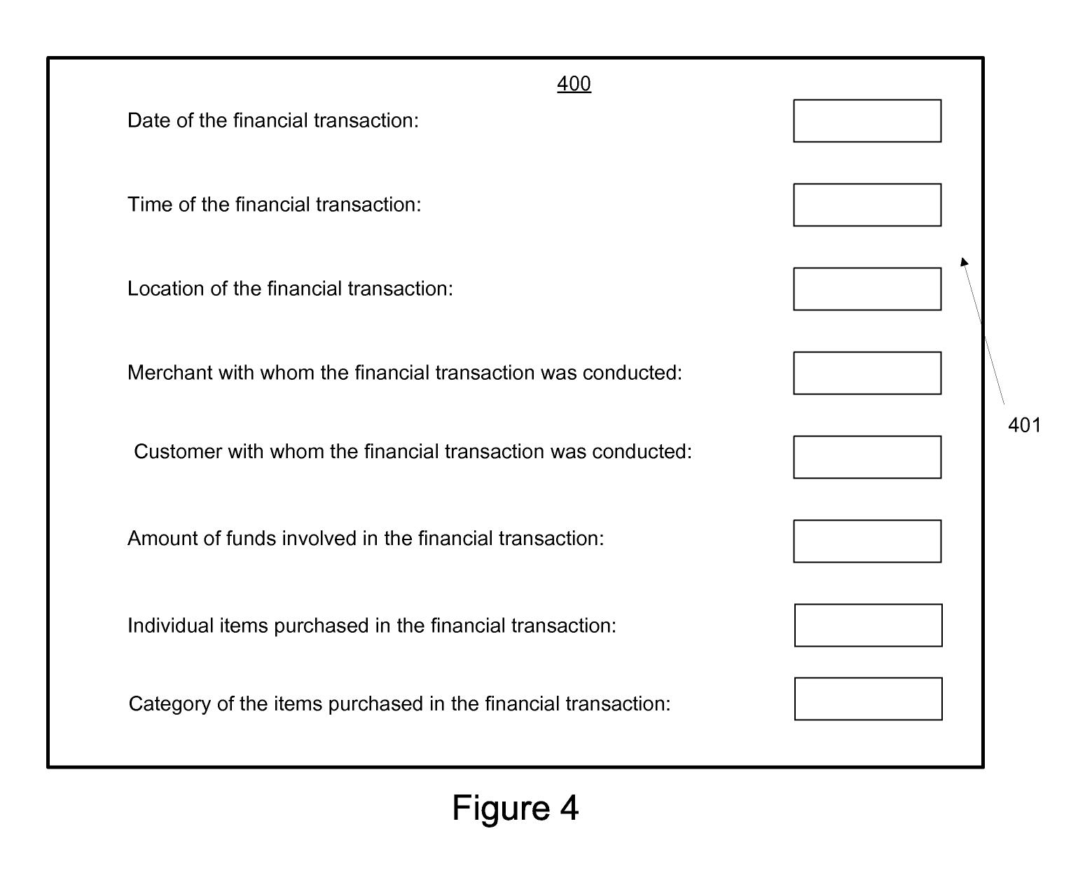

According to aspects of the disclosure, alternatively, or in addition to uploading a copy of the receipt, the web based interface may allow the customer 201 to manually enter information regarding the financial transaction. FIG. 4 is a screen shot of an illustrative embodiment of a web-based interface 400 according to aspects of the disclosure. As seen in FIG. 4), the web-based interface 400 may include fields 401 for the customer 201 to enter such financial transaction data as: the date of the financial transaction, time of the financial transaction, location of the financial transaction, the identity of the merchant 203 or customer 201 involved with the financial transaction, the amount of funds involved in the financial transaction, the individual items purchased in the financial transaction, etc. Of course, it is noted that the software described above may also populate such fields 401 based on the information obtained from the scanned in receipts. Therefore, it is understood that transaction data may be obtained by: the customer entering it manually, the software extracting the financial transaction data from the receipt, or a combination of such methods. Of course, other methods of obtaining the financial transaction information may be used as well.

Regardless of how the financial transaction data is entered into the computer system 207, according to aspects of the disclosure, the computer system 207 may process the information to categorize the financial transaction data. For example, the computer system 207 may be configured to classify the individual items involved in the financial transaction (e.g., items purchased) into different categories or genres. For example, individual items may be stored and listed by name (e.g., bananas, airplane ticket, Video Game—Professional Football 2010), but also categorized into categories, such as: travel, groceries, utilities, restaurants, department stores, home furnishings, electronics, tickets for events, etc. For example, the computer system 207 may have software which configures it to recognize names of items, merchants, etc. and, thereby, categorize the items or purchases into categories based on the names of items, merchants, etc. Further, the financial transaction data may be categorized based on the above described characteristics: the date of the financial transaction, and time of the financial transaction, location of the financial transaction, the identity of the merchant 203 or customer 201 involved with the financial transaction, the amount of funds involved in the financial transaction, the individual items purchased in the financial transaction, etc. Hence, it is understood that the financial transaction data received by the computer system 207 may be coordinated and classified such that the data is stored in the financial transaction database 209 so that it is easily and reliably retrieved by the search queries of the computer system. According to aspects of this disclosure, once the receipt itself and/or information regarding the financial transaction is submitted to the organization 205 for use in the leveraging system 200, the organization 205 may review the information obtained the receipt and/or the receipt itself and determine whether the receipt and the information are acceptable for use in the system 200. For example, according to aspects of the disclosure, the organization 205 may be notified that a receipt from a particular personal account has been submitted (e.g., via an automatic email that is generated and transmitted to the organization 205 upon the customer 201 submitting an uploaded receipt for review by the organization 205 and/or when the OCR software has reviewed the receipt, extracted data from the receipt and processed the data as described above). The organization 205 may then review the information from the receipt and/or the receipt itself to determine whether the receipt itself and the information from the receipt is legitimate (e.g., that the receipt corresponds to a purchase made using funds an account the customer has with the bank), free of mistakes (e.g., the receipt is legible, the information from the receipt has been extracted and categorized correctly by the OCR), conforms to formats that may be required by the advertising system 200 (e.g., dimensions of the receipt, quality of the image, etc.), etc. If the receipt itself and the information from the receipt is approved by the organization 205, then the receipt itself and the information from the receipt may be transmitted to the financial transaction database 209 and the customer 201 may be notified by the organization 205 of the approval (e.g., an email may be sent to the customer's email address that is registered with the organization 205). Of course, it is noted that a bank associate reviewing the receipt itself or the information extracted from the receipt may have the opportunity to correct any errors made by the customer or the OCR prior the financial transaction data being approved. As discussed above, once the financial transaction has been approved by the organization 205, the financial transaction data may be transmitted to the financial transaction database 209.

The financial transaction database 209 may be a database which stores all financial transaction data for customers of the bank. For example, the financial transaction database 209 may store the above described data from approved transactions or receipts submitted by the customers 201. Further, the financial transaction database 209 may also store financial transaction history data for customers of the bank, such as financial transactions related to customer accounts (e.g., deposit accounts, checking accounts, savings accounts, mortgage accounts, etc.). For example, the financial transaction database 209 may store debit card purchases, ATM withdrawals, deposits, balance transfers, etc. The financial transaction database 209 may store such information in individual accounts within the financial transaction database 209 for each of the customers of the bank. Further, the financial transaction database 209 may store the above described data from approved transactions or receipts submitted by the customers 201 in the above described categories, such as the date of the financial transaction, and time of the financial transaction, location of the financial transaction, the identity of the merchant 203 or customer 201 involved with the financial transaction, the amount of funds involved in the financial transaction, the individual items purchased in the financial transaction, the category into which the items purchased relate (e.g., travel, groceries, utilities, restaurants, department stores, home furnishings, electronics, tickets for events, etc.).

According to aspects of the disclosure, the system for leveraging financial transaction and other demographic data 200 may include features which allow the data in the financial transaction database 209 to be encrypted or de-personalized. For example, the system for leveraging financial transaction and other demographic data 200 may include an algorithm which encrypts the data in the financial transaction database 209 (e.g., a customer's name or transaction record would be encrypted). By way of example, if a customer's name was John Smith, the name “John Smith” may be encrypted by the algorithm to be an indecipherable alphanumeric sequence (e.g., A%#984V211.98). Other information in the financial transaction database 209 (or other databases) could be encrypted similarly. According to aspects of the disclosure, the bank may have a key for decrypting the data. In this way, hackers or others are prevented from unmasking the identities of customers, the transaction records, etc.

As mentioned above, according to aspects of the disclosure, the system for leveraging financial transaction and other demographic data 200 may leverage such financial transaction information in order to provide a more accurate picture of the individual customers, their spending habits and demographic information (and, thereby, the same picture at the bank's customers at an aggregate level). Specifically, the system for leveraging financial transaction and other demographic data 200 may extract data from one or both of the customer profile database 210 and the financial transaction database 209 and merge and associate the extracted data in order to provide an accurate picture of the customer, their spending habits and demographic information (and, thereby, the same picture at the bank's customers at an aggregate level). This process will be described in detail below.

According to aspects of this disclosure, the computer system for processing data and/or associating customer data and transaction data 211 may be configured to search for, indentify, extract and process data from the financial transaction database 209 and the customer profile database 210. For example, the computer system 211 may be configured so a user is able to specify which particular data the user wants to search for, identify, extract and process. For example, the user may specify that the customer profile database 210 is to be searched for a particular demographic of customers of the bank (e.g., an age range of customers). Further, such customer profile accounts matching the particular search criteria may be identified and data from those customer profile accounts may be extracted and processed. As another example, the user may specify that the accounts in the financial transaction database 209 are to be searched for particular information relating to customers of the bank (e.g., customers who purchased a particular good or service, i.e., an item). Further, accounts with financial transaction data matching the particular search criteria may be identified and data from those financial transaction accounts in the financial transaction database 209 may be extracted and processed. The data from the searches of the two databases may be merged, associated or otherwise processed in order to provide further information. For example, according to the aspects of the disclosure, the information on the customers identified in the first search may be merged with the information on the customers identified in the second search in order to create a new list of customers who meet both criteria. Further, according to the other aspects of the disclosure, the information from the first search may be used as one of the search criteria in the second search.

Further, according to aspects of the disclosure, the computer system 211 may correlate and leverage the data indentified and extracted from one database as search criteria in the other database. For example, according to aspects of the disclosure, the computer system 211 may search for and extract data from the customer profile database 210 and then use that identified information as a search query for obtaining information from the financial transaction database 209. For example, the computer system 211 may search the customer profile database 210 for accounts of males with ages between 20-34 years of age. Then, the computer system 211 may indentify and extract such data and then leverage that identified information as a search query for obtaining information from the financial transaction database 209. For example, the computer system 211 may search the financial transaction database 209 for financial transaction accounts associated with the persons identified in the first search (i.e., the male customers between 20-34 years of age) and also, of those accounts, which have spent a predetermined amount of funds over a predetermined amount of time (e.g., $20 in the past six months) on a particular item(s) (e.g., video games or video game accessories). Conversely, the computer system 211 may search the financial transaction database 209 for accounts meeting a particular criteria (e.g., customers who have purchased a particular item) and then may indentify and extract such data in order to leverage that identified information as a search query for obtaining information from the customer profile database 210 (e.g., which of the identified customers who have purchased the particular good or service are female and within an age range of 30-40).

Hence, it is understood that the above described customer data and transaction data can be searched for a variety of characteristics (e.g., spending habits, demographic information, etc.). Regardless of which databases are searched, what characteristics are used as criteria, which financial transaction or other demographic information is obtained, the relevant data may be compiled into a format that is useful for providing accurate demographic information (e.g., at an aggregate level) that may be used for advertising purposes. Hence, it is understood, that according to one or more aspects of this disclosure, the bank may employ the computer systems 211 to search for, indentify, extract and process data the bank already has (e.g., data from the one or more databases containing customer profile information and/or financial transaction data) in order to leverage such information to provide accurate demographic information that may be used for advertising purposes.

Described below is an illustrative process, according to one aspect of the disclosure, for associating and processing financial transaction data and customer profile data in order to leverage such data to provide accurate demographic information that may be used for advertising purposes. Initially, a user of the computer system 211 may define search criteria. In this illustrative example, an advertiser 213 may be interested in advertising a video game for use on a home video gaming system. The advertiser 213 may know that its target audience for the video game is comprised of males who are 20-34 years and have an income of up to $50,000. Based on this information, the user of the computer system 211 may use the computer system 211 to search the customer profile database 210 for accounts that meet the search criteria of males who are within the age range and income range described above. The computer system 211 may extract such information from customer profile database 210 and determine demographic information of the customers such as, the residential addresses of the customers who are associated with the identified accounts. Such demographic information may be extracted from the customer profile database 210 by the computer system 211. For example, the residence information of the identified customers may be extracted from the residence information of the customer that is stored in the customer profile database 210. According to aspects of the disclosure, the computer system 211 may compile a list of cities or zip codes ranking the cities or zip codes with the highest concentrations of such customers. Hence, the computer system 211 may provide the advertiser 213 with a prioritized list of particular geographic areas in which to advertise. Hence, if a high percentage of customers who meet the search criteria are situated in a particular city or zip code, as a result the advertiser 213 may decide to advertise via mass media, such as purchasing television spots, radio spots, billboards, etc. in that geographic area. For example, if Austin, Tex. were ranked as having a high concentration of 20-34 year old males who have an income of up to $50,000, then the advertiser 213 may wish to consider purchasing television spots, radio spots, billboards, etc. in Austin, Tex. over other geographic areas with a lower concentration of 20-34 year old males who have an income of up to $50,000.

According to other aspects of the disclosure, the computer system 211 may also leverage data on a customer financial transaction history data in order to provide demographic information that may be used for advertising purposes. For example, the user of the computer system 211 may search the customer profile database 210 as described above to identify customers of the bank who are 20-34 year old males with an income of up to $50,000. The computer system 211 may then search the financial transaction database 209 for data using the above indentified accounts of customers of the bank (i.e., 20-34 year old males who have an income of up to $50,000) as a search criterion. For example, the search criteria may be configured to identify which of the accounts associated with the already identified bank customers have financial transaction history data which indicates the customers purchased subscriptions to at least one magazine using funds from their account with the bank. In other words, the computer system 211 may search the financial transaction database 209 for any accounts of the 20-34 year old males who have an income of up to $50,000 and have paid for subscriptions to magazines with debit card purchases, automated debits, etc. Further, the computer system 211 may indentify the names of the magazines that are purchased (e.g., if the names of the magazines are stored and listed under the items category) and rank the particular magazines from the most purchased to the least purchased. Hence, the computer system 211 may provide the advertiser 213 with demographic information regarding how many customers purchase magazines (and, therefore, whether it would be worthwhile to do an advertising campaign in print advertisements). Further, the computer system 211 may provide the advertiser 213 with a prioritized list of which magazines in which the advertiser 213 may want to advertise.

According to another illustrative aspect of the disclosure, the computer system 211 may provide the advertiser 213 with information regarding their target audience. For example, according to aspects of the disclosure, the computer system 211 may leverage financial transaction data and customer data to identify a target audience for the advertiser 213.

For example, in the above described example, the advertiser 213 wishes to advertise a video game for a home video game system. However, unlike the above example, here, the advertiser is not aware of the target audience. According to aspects of the disclosure, the user of the computer system 211 may search the financial transaction database 209 for any financial transaction history data which would indicate that the user is likely to purchase the video game. For example, the user of the computer system 211 may include search criteria of: video games, video game systems, video game accessories, etc. in the above described category of “items purchased.” Similarly, the user of the computer system 211 may include search criteria of the names of stores specializing in sales of video games, video game systems and video game accessories in the above described category of “merchant.”

Once the computer system for 211 has identified those accounts that have either purchased video games, video game systems, video game accessories, etc. (e.g., as determined by searching the “items purchased” category of individual accounts in the financial transaction database 209 for such items or searching the financial transaction history data for names of such items) or made purchases from stores specializing in sales of video games, video game systems and video game accessories, etc. (e.g., as determined by searching the “merchant” category of individual accounts in the financial transaction database 209 for such merchants or searching the financial transaction history data for names of such merchants) then those accounts may be correlated with the customer profile information to identify other demographic information that would be useful for advertising purposes. For example, the computer system 211 may identify and extract the demographic information for each of the identified accounts. Further, computer system f 211 may also compile an aggregated and anonymous list of demographic information based on the information extracted from the databases 209, 210. For example, the computer system 211 may determine and compile a list showing that bank customers who are male, 18-25 with an income of $40,000 or less are the largest concentration of bank customers who have either purchased video games, video game systems, video game accessories, etc. or made purchases from stores specializing in sales of video games, video game systems and video game accessories. Such compiled demographic information may be useful to the advertiser to target their advertising.

Hence, it is understood that according to aspects of the disclosure, the computer system 211 may leverage financial transaction information (e.g., spending habits) and/or customer profile information (e.g., other demographic information) in order provide an advertiser with information regarding their target audience. Regardless of the information that is determined by the system 200, as seen in FIG. 2, the information may be transmitted to the advertiser 213 by the computer system 211. It is noted that according to aspects of the disclosure, the information transmitted to the advertiser 213 may be purely anonymous with respect to the individual bank customers from whom it was determined. In other words, no information identifying the customers (e.g., names, social security numbers, etc.) would be forwarded to the advertiser 213. Instead, according to aspects of the disclosure, the information may be at an aggregate level. In other words, the information determined by the computer system 211 may identify aggregate groups of bank customers instead of individual bank customers.

It is noted that, as discussed above, according to aspects of the disclosure, a customer 201 may upload financial transaction data to the computer system for receiving transaction data 207. According to aspects of the disclosure, the customer may be provided with an incentive for uploading such financial transaction data. For example, the customer 201 may be provided with a rebate or discount (e.g., a coupon) from the manufacturers of products listed on the receipt. For example, according to aspects of the disclosure, manufacturers may be associated with the system 200 and, therefore, the coupons may be mailed or emailed to the customer upon the system 200 notifying the manufacturers of the financial transaction information (e.g., after the items have been identified or categorized by the computer system 207). According to other aspects of the disclosure, the customer 201 may be provided with incentives directly from the bank. For example, the bank may provide an incentive such as promotional materials, preferential treatment, discounts on interest rates on loans, monetary incentives, etc. for registering and participating in the system 200 and providing a predetermined amount of receipts or financial transaction data.

It is noted that in the above described examples, the customer 201 provides the computer for receiving transaction data 207 with information from the financial transaction between the customer 201 and the merchant 203. However, according to other aspects of the disclosure, the merchant 203 may provide such information to the computer for receiving information regarding the financial transaction 207. In other words, data from the financial transaction between the customer 201 and the merchant 203 may be transmitted directly from the merchant to bank. For example, each time a customer uses a bank issued credit card, debit card, check, etc. to make a purchase, the merchant 203 may validate the method of payment by transmitting information to the bank. The bank may transmit information back to the user to validate the payment and, further, update the bank's own records regarding the account. This backend transaction of information between the merchant and bank may also be used to transmit further information about the financial transaction.

For example, instead of transmitting information merely to validate the financial transaction, the same equipment may be used to transmit further financial transaction data, such as the items purchased. For example, if a customer 201 were conducting a financial transaction with a merchant 203 in which the customer is buying four items from the merchant is using a bank issued debit card to purchase such items, the data from the merchant's register that is processing the transaction (e.g., such as the date of the financial transaction, and time of the financial transaction, location of the financial transaction, the identity of the merchant 203 or customer 201 involved with the financial transaction, the amount of funds involved in the financial transaction, the individual items purchased in the financial transaction) may be provided directly to the bank 205, such as seen in FIG. 2.

According to additional aspects of this disclosure, the system for leveraging financial transaction and other demographic data 200 can provide information regarding the effectiveness of an advertisement to the advertiser 213 (e.g., as a value added service to the advertiser 213). Therefore, the advertiser 213 may be able to leverage such information provided by the system 200 to analyze the effectiveness of their advertisements and potentially modify their advertising strategy.

According to aspects of the disclosure, a mass media advertisement by the advertiser may issue a “call to action” for the customer. For example, the mass media advertisement may include a discount if the customer purchases a particular product. According to aspects of the invention, a coupon may be issued with the advertisement. If the financial transaction includes the coupon, such information may be included in the financial transaction data uploaded to the computer for receiving transaction data 207 (e.g., the coupon may be included in the receipt or may be included in the financial transaction information forwarded by the merchant 203 or customer 201). For example, in the situation wherein a customer 201 of the transaction obtains a coupon from the advertisement, according to aspects of the disclosure, an identifier of the coupon may be embedded in the receipt of the transaction wherein the coupon is used to purchase the product. For example, when the coupon is scanned or manually entered, the merchant's register may be configured to cause the receipt to include an alphanumerical code, data glyph, bar code, etc. which contains the information that the coupon was used in the transaction. According to aspects of the disclosure, such financial transaction data may be recognized, categorized and stored in the financial transaction database 209. Hence, the computer system 211 may search for and identify accounts in the financial transaction database 209 wherein the coupon was used. Hence, the computer system 211 may extract and compile such information for the advertiser 213 in order to provide an indication of how effective the advertisement was on the audience.

It is noted, of course, other indicators of the effectiveness of the advertisement may be used instead of a coupon. For example, the mass media advertisement may include a discount if the customer purchases the product within a week of the advertisement or during another predetermined time. Hence, according to aspects of the disclosure, such temporal transaction data may be recognized, categorized and stored in the financial transaction database 209. Hence, the computer system 211 may search for and identify accounts in the financial transaction database 209 wherein the product was purchased with the particular time period. Hence, as described above, the computer system 211 may extract and compile such information for the advertiser 213 in order to provide an indication of how effective the advertisement was on the audience.

The above described information about the effectiveness of the advertisement may be useful to the advertiser 213. The advertiser 213 may analyze the information to determine many aspects related to the effectiveness of the advertisement. For example, the advertiser 213 may determine if the advertisement is more effective: in particular location, during a particular time of day, on a particular television channel, radio station or magazine, newspaper, for a particular demographic of people (e.g., age, sex, income level, type of household, etc.), etc. The advertiser 213 could then leverage such information in order to determine if the advertiser 213 should consider modifying one or more of their advertisements or their entire advertising campaign in order to increase its effectiveness.

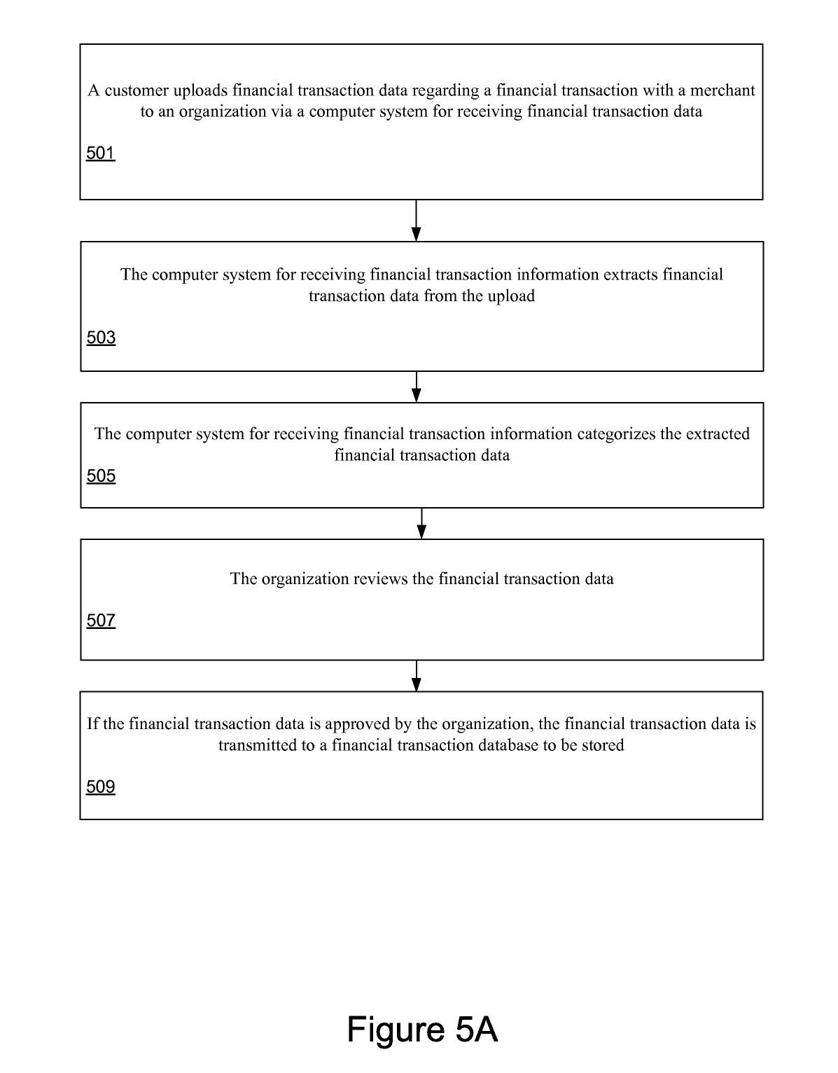

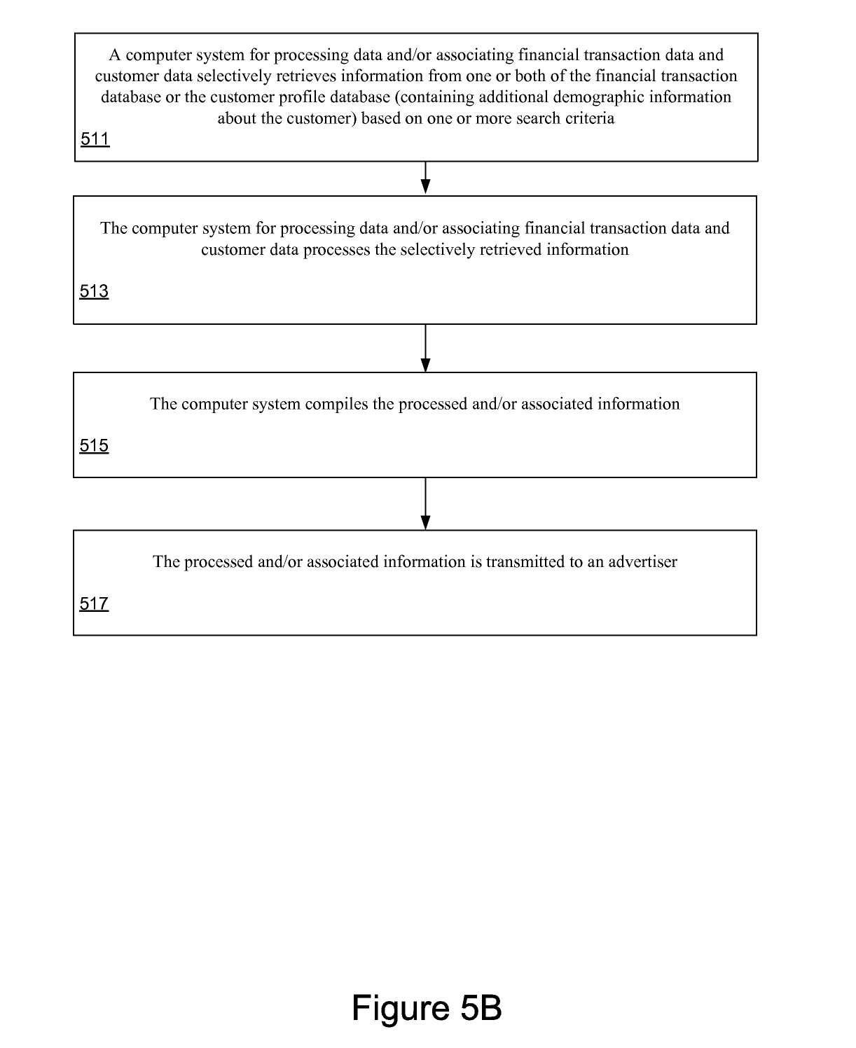

FIG. 5 is a flow chart which demonstrates an illustrative method for leveraging financial transaction data and other demographic data according to an aspect of the disclosure. As seen in FIG. 5, in step 501 a customer 201 uploads financial transaction data regarding a financial transaction with a merchant 203 (e.g., a receipt from the transaction) to an organization 205 via a computer system for receiving financial transaction data 207. In step 503, the computer system for receiving financial transaction information 207 extracts financial transaction data from the upload. In step 505, the computer system for receiving financial transaction information 207 categorizes the extracted financial transaction data. In step 507, the organization 205 reviews the financial transaction data. In step 509, if the financial transaction data is approved by the organization, the financial transaction data is transmitted to a financial transaction database 209 to be stored. In step 511, a computer system 211 for processing data and/or associating financial transaction data and customer data selectively retrieves information from one or both of the financial transaction database 209 or the customer profile database 210 (containing additional demographic information) based on one or more search criteria. In step 513, the computer system for processing data and/or associating financial transaction data and customer data 211 processes the selectively retrieved information. In step 515, the computer system 211 compiles the processed and/or associated information. In step 517, the processed and/or associated information is transmitted to an advertiser 213.

It is noted that the system 200 may be an electronically based system. For example, the system 200 may include a computer (such as described above), a network of computers, software that configures a computer to perform the above described features, etc. The data, such as the financial transaction data, customer data, etc. may be electronically transmitted and received by the different elements of the system 200.

While illustrative systems and methods as described herein embodying various aspects of the present disclosure are shown, it will be understood by those skilled in the art, that the disclosure is not limited to these embodiments. Modifications may be made by those skilled in the art, particularly in light of the foregoing teachings. For example, each of the features of the aforementioned illustrative examples may be utilized alone or in combination or subcombination with elements of the other examples. It will also be appreciated and understood that modifications may be made without departing from the true spirit and scope of the present disclosure. The description is thus to be regarded as illustrative instead of restrictive on the present disclosure.

1. A computer assisted method for selecting a potential audience for an advertisement comprising:
electronically receiving data relating to at least one financial transaction between a customer of an organization and a third party;
electronically receiving data relating to at least one demographic of the customer;
using a demographic evaluation computer to determine a potential audience for an advertisement based on the financial transaction data and the demographic data by:
searching the electronically received demographic data for data that matches a first criterion which is related to the demographic data;
searching the electronically received financial transaction data for data that matches a second criterion which is related to the financial transaction data;
comparing the data that matches a first criterion with the data that matches the second criterion to determine which of the data matching the first criterion and the data matching the second criterion matches both the first and the second criterion; and
compiling the data which matches both the first and the second criterion,
wherein the first criterion includes a first characteristic of an intended audience to which the advertisement is to be presented,
wherein the second criterion includes a second characteristic of an intended audience to which the advertisement is to be presented,
wherein searching the electronically received financial transaction data includes searching a database storing financial transaction data including financial transaction history associated with an account held with a bank.

2. The computer assisted method of claim 1, wherein the data relating to at least one financial transaction between a customer of an organization and a third party is information from a receipt of the financial transaction between the customer of an organization and the third party.

3. The computer assisted method of claim 2, wherein the data relating to at least one financial transaction between a customer of an organization and a third party is extracted from an electronic copy of the receipt that has been uploaded to the organization.

4. The computer assisted method of claim 3, wherein the data relating to at least one financial transaction between a customer of an organization and a third party is extracted from an electronic copy of the receipt by an Optical Character Recognition system.

5. The computer assisted method of claim 1, wherein the data relating to at least one financial transaction between a customer of an organization and a third party includes at least one of: the date of the financial transaction, and time of the financial transaction, location of the financial transaction, the identity of the merchant or customer involved with the financial transaction, the amount of funds involved in the financial transaction and the individual items purchased in the financial transaction.

6. The computer assisted method of claim 5, wherein the data relating to at least one financial transaction between a customer of an organization and a third party is categorized based on the information it contains.

7. The computer assisted method of claim 1, wherein the data relating to at least one demographic of the customer includes at least one of: customer name, address, telephone number, email address, age, credit score, income, place of employment, type of household, type of residence, the type of financial relationship/account with the organization, term of the relationship with the organization, particular relevant financial amounts in the relationship with the organization, and bank account numbers.

8. The computer assisted method of claim 1, wherein the organization is the bank at which the account is held.

9. The computer assisted method of claim 1, wherein the compiled data is reordered or prioritized based on at least a third criterion.

10. A demographic evaluation computer comprising:
a processor; and
memory storing computer executable instructions that, when executed, cause the demographic evaluation computer to perform a method for selecting a potential audience for an advertisement by:
electronically receiving data relating to at least one financial transaction between a customer of an organization and a third party;
electronically receiving data relating to at least one demographic of the customer;
determining a potential audience for an advertisement based on the financial transaction data and the demographic data by:
searching the electronically received demographic data for data that matches a first criterion which is related to the demographic data;
searching the electronically received financial transaction data for data that matches a second criterion which is related to the financial transaction data;
comparing the data that matches a first criterion with the data that matches the second criterion to determine which of the data matching the first criterion and the data matching the second criterion matches both the first and the second criterion; and
compiling the data which matches both the first and the second criterion,
wherein the first criterion includes a first characteristic of an intended audience to which the advertisement is to be presented,
wherein the second criterion includes a second characteristic of an intended audience to which the advertisement is to be presented,
wherein searching the electronically received financial transaction data includes searching a database storing financial transaction data including financial transaction history associated with an account held with a bank.

11. The computer according to claim 10, wherein the data relating to at least one financial transaction between a customer of an organization and a third party is information from a receipt of the financial transaction between the customer of an organization and the third party.

12. The computer according to claim 11, wherein the data relating to at least one financial transaction between a customer of an organization and a third party is extracted from an electronic copy of the receipt that has been uploaded to the organization.

13. The computer according to claim 12, wherein the data relating to at least one financial transaction between a customer of an organization and a third party is extracted from an electronic copy of the receipt by an Optical Character Recognition system.

14. The computer according to claim 10, wherein the data relating to at least one financial transaction between a customer of an organization and a third party includes at least one of: the date of the financial transaction, and time of the financial transaction, location of the financial transaction, the identity of the merchant or customer involved with the financial transaction, the amount of funds involved in the financial transaction and the individual items purchased in the financial transaction.

15. The computer according to claim 14, wherein the data relating to at least one financial transaction between a customer of an organization and a third party is categorized based on the information it contains.

16. The computer according to claim 10, wherein the data relating to at least one demographic of the customer includes at least one of: customer name, address, telephone number, email address, age, credit score, income, place of employment, type of household, type of residence, the type of financial relationship/account with the organization, term of the relationship with the organization, particular relevant financial amounts in the relationship with the organization, and bank account numbers.

17. The computer according to claim 10, wherein the organization is the bank at which the account is held.

18. The computer according to claim 10, wherein the compiled data is reordered or prioritized based on at least a third criterion.

19. A demographic evaluation computer comprising:
a processor; and
memory storing computer executable instructions that, when executed, cause the demographic evaluation computer to perform a method for selecting a potential audience for an advertisement by:
electronically receiving financial transaction history data of one or more customer of a bank;
determining a potential audience for an advertisement based on the financial transaction history data by:
searching the electronically received financial transaction history data for data that matches a first criterion which is related to the financial transaction history data; and
compiling the data which matches the first criterion,
wherein the first criterion includes a first characteristic of an intended audience to which the advertisement is to be presented.

20. The computer according to claim 19, wherein the wherein method for selecting a potential audience for an advertisement further comprises:
electronically receiving data relating to at least one demographic of the customer;
searching the electronically received demographic data for data that matches a second criterion which is related to the demographic data;
comparing the data that matches a first criterion with the data that matches the second criterion to determine which of the data matching the first criterion and the data matching the second criterion matches both the first and the second criterion; and
compiling the data which matches both the first and the second criterion,
wherein the second criterion includes a first characteristic of an intended audience to which the advertisement is to be presented.
